(19) United States
(12) Patent Application Publication
(10) Pub. No.: US 2012/0292298 A1
(43) Pub. Date: Nov. 22, 2012

(54) Electric Vehicle Compact Coolant Heater

(76) Inventors: PHILIP J. FLEURY, St. Francois Xavier (CA); DARRELL VAN MOL, Winnipeg (CA)

(21) Appl. No.: 13/109,376

(22) Filed: May 17, 2011

(51) Int. Cl. B60L 1/02

(52) U.S. Cl. 219/202

(57) ABSTRACT

An electric vehicle battery heater includes a housing having a coolant inlet and a coolant outlet. A heating element is positioned within the housing and includes a helical coil portion positioned between parallel and axially extending end portions. The end portions extend outside of the housing. A thermistor is positioned in the housing to output a signal indicative of a temperature of a coolant in heat transfer relation with an electric vehicle battery. The heating element is energized when the signal represents a coolant temperature being less than a predetermined lower limit.

### FIELD

The present disclosure generally relates to an electric heater for a vehicle. More particularly, a lightweight, compact electric coolant heater is provided to warm a battery of an electric vehicle.

### BACKGROUND

Vehicles equipped with an electric motor to transfer drive torque to the driven wheels are becoming desirable by a greater number of users than ever before. Electric vehicles may eliminate undesirable emissions exhausted by internal combustion engines. Additionally, battery technology has developed to the point where a reasonably sized battery pack may output sufficient energy to drive the electric motor and meet a driver's needs for acceleration and range. To provide a usable vehicle in the field, the battery pack must also be efficiently charged and discharged many times.

One challenge facing electric vehicle designers includes the sensitivity of the electric vehicle batteries to temperature. More specifically, the maximum charge current and the maximum discharge current of the batteries vary based on battery temperature, among other things. The temperature of the battery may vary during operation due to chemical reactions taking place within the battery as well as the ambient temperature of the environment in which the vehicle is positioned. For example, the maximum charging current of a battery may be significantly reduced when the temperature of the battery is below a predetermined limit. Battery charging and discharging may also be less than optimal when the temperature of the battery is above a predetermined operating limit.

Furthermore, existing heaters for vehicle engines may not be suited to warm an electric vehicle battery pack. Some known heaters occupy a larger space than would be allowed in an electric vehicle. Previously known heating elements may be relatively long and include portions that are widely spaced apart for simplified coolant flow around the heating element. Prior electric heaters may include a relatively large coolant chamber to provide a significant volume of coolant in a heat transfer relationship with the heating element. Unfortunately, due to relatively stringent packaging restraints, current heaters may not conform to an electric vehicle manufacturer's specifications. It may be beneficial to provide a compact coolant heater to assure efficient operation of the vehicle batteries.

### SUMMARY

This section provides a general summary of the disclosure, and is not a comprehensive disclosure of its full scope or all of its features.

An electric vehicle battery heater includes a housing having a coolant inlet and a coolant outlet. A heating element is positioned within the housing and includes a helical coil portion positioned between parallel and axially extending end portions. The end portions extend outside of the housing. A thermistor is positioned in the housing to output a signal indicative of a temperature of a coolant in heat transfer relation with an electric vehicle battery. The heating element is energized when the signal represents a coolant temperature being less than a predetermined lower limit.

An electric vehicle battery heater includes a housing having a first end with an inlet and an opposite second end having an outlet. The inlet has an inlet axis extending parallel to and offset from an axis of the outlet. A heating element is positioned within the housing in a heat transfer relationship with a fluid passing from the inlet to the outlet. The heating element includes a helical portion defining a helix axis extending parallel to and offset from each of the inlet and outlet axes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic depicting an exemplary vehicle including an electric vehicle battery temperature control system;

FIG. 2 is a perspective view of an electric vehicle battery heater;

FIG. 3 is a side view of the heater shown in FIG. 2;

FIG. 4 is a cross-sectional view of the heater taken along line 4-4 as shown in FIG. 2;

FIG. 5 is a cross-sectional view through the heater taken along line 5-5 as shown in FIG. 3;

FIG. 6 is a perspective view of a heating element;

FIG. 7 is an end view of the heating element;

FIG. 8 is a fragmentary exploded perspective view of a wire harness associated with the electric vehicle battery heater;

FIG. 9 is a fragmentary side view of a portion of the wire harness shown in FIG. 8;

FIG. 10 is a side view depicting coupling a wire harness to an electric vehicle battery heater; and

FIG. 11 is a side view depicting the wire harness coupled to the electric vehicle battery heater.

Corresponding reference numerals indicate corresponding parts throughout the several views of the drawings.

### DETAILED DESCRIPTION

Example embodiments will now be described more fully with reference to the accompanying drawings.

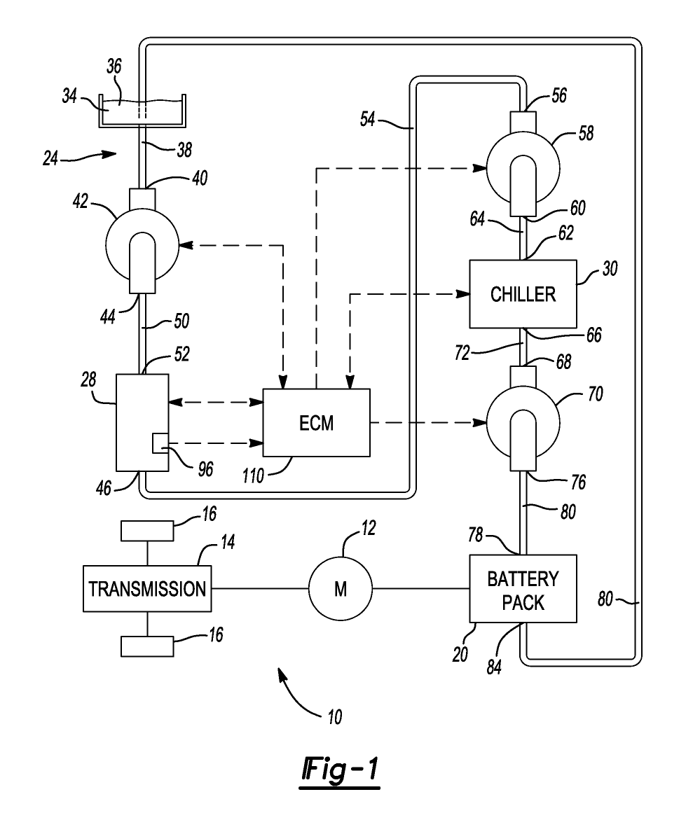

An exemplary electric vehicle is schematically depicted in FIG. 1 at reference numeral 10. Electric vehicle 10 includes an electric motor 12 drivingly coupled to a transmission 14. Transmission 14 provides output torque to at least one of wheels 16. A battery pack 20 provides electrical energy to motor 12.

A battery thermal management system 24 is mounted on vehicle 10 to maintain battery pack 20 within a predetermined operating temperature range. For example, it may be desirable to maintain battery pack 20 within an operating range of substantially 50-100° F. The charging and discharging characteristics of the batteries within battery pack 20 are most efficient at this temperature range. Battery thermal management system 24 achieves this goal by circulating a coolant through battery pack 20 to transfer heat between the coolant and the battery pack. When the battery temperature is lower than a predetermined lower limit, an electric heater 28 may be energized to heat coolant flowing in a heat transfer relationship to individual batteries or portions of battery pack 20. Should the operating temperature of battery pack 20 be greater than a predetermined upper limit, a chiller 30 reduces the temperature of the coolant flowing around or through battery pack 20.

Battery thermal management system 24 also includes a reservoir 34 containing a coolant 36. A supply line 38 is plumbed in communication with an inlet 40 of a first pump 42. Pressurized fluid is provided from an outlet 44 of first pump 42 to an inlet 52 of coolant heater 28 via a line 50. Coolant heater 28 includes an outlet 46 through which coolant flows via a line 54 to an inlet 56 of a second pump 58. An outlet 60 of second pump 58 provides pressurized fluid to an inlet 62 of chiller 30 via a coolant line 64. An outlet 66 of chiller 30 is plumbed in fluid communication with an inlet 68 of a third pump 70. A line 72 interconnects outlet 66 and inlet 68. Pump 70 includes an outlet 76 providing pressurized fluid to inlet 78 of battery pack 20 via a coolant line 80. An outlet 84 of battery pack 20 supplies fluid to return line 80 and reservoir 34. Within battery pack 20, a plurality of parallel paths may exist between inlet 78 and outlet 84. On the other hand, a single serpentine pathway may be positioned in thermal conductivity with portions of batteries, groups of batteries, or housings mounting the batteries within battery pack 20 to efficiently transfer heat. Furthermore, other systems including less than three pumps are contemplated as being within the scope of the present disclosure.

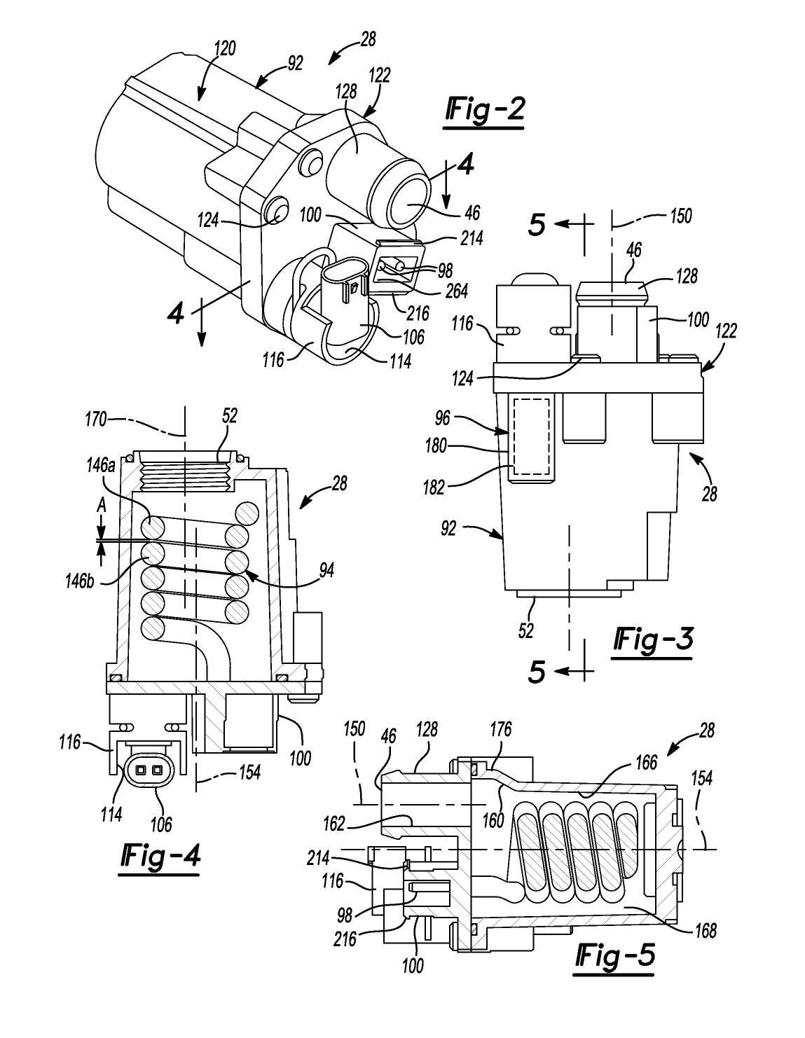

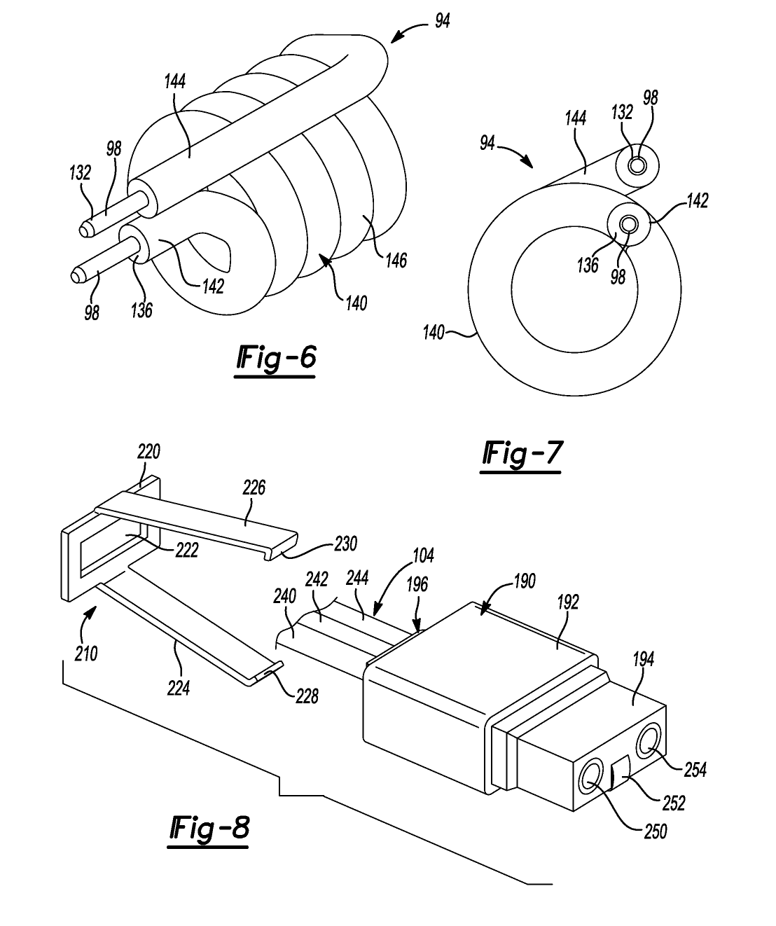

As shown in FIGS. 2-7, coolant heater 28 includes a housing 92, a resistive heating element 94 and a thermistor 96. Terminal pins 98 of heating element 94 protrude through housing 92 and are surrounded by a first boss 100. Terminal pins 98 are in electrical communication with heating element 94 and are adapted to be electrically coupled to a wire harness 104 for supplying electrical energy to heater 28. An electrical connector 106 is associated with thermistor 96 to allow transmission of a signal indicative of a temperature of the coolant within housing 92 to a controller 110. Connector 106 is positioned within a pocket 114 defined by a second boss 116 of housing 92. Housing 92 includes a body 120 fixed to a cap 122 by a plurality of fasteners 124. Body 120 and cap 122 may be cast metal components. Cap 122 includes first boss 100, second boss 116 and a third boss 128 defining outlet 46.

To meet target heater size and performance specifications, resistive heating element 94 includes a particular geometry to provide a desired watt density in a relatively small packaging volume. In particular, it may be desirable to provide a watt density of approximately 133 watts per square inch. This may be accomplished by providing an 1800 watt heating element having an external surface area of 15 square inches. The volume defined by heating element 94 is approximately 1 cubic inch. Heating element 94 includes a metallic resistive wire 132 coated for a majority of its length by a sheath 136. Terminal pins 98 are shaped as elongated pins at each end of wire 132. To achieve the small packaging volume, heating element 94 includes a helical portion 140 positioned between a first linear portion 142 and a second linear portion 144. Helical portion 140 has an outer diameter of approximately 1.25 inches and a helix of approximately 3.5 turns per inch. The outer diameter of sheath 136 is approximately one-quarter of one inch. An axial spacing A between adjacent wraps 146a, 146b is less than one-half of the outer diameter of resistive element 94. First linear portion 142 extends along a longitudinal axis that is parallel to and spaced apart from a longitudinal axis of second linear portion 144. The axes are spaced apart from one another approximately three-eighths of one inch.

It is also desirable to minimize the restriction to coolant flow through heater 28 while optimizing heat transfer from resistive element 94 to coolant 36. The design of housing 92 in cooperation with the size and shape of resistive element 94 provide these performance characteristics. In particular, outlet 46 extends along an outlet axis 150. Helical portion 140 is wound about a helix axis 154. Outlet axis 150 extends substantially parallel to and offset from helix axis 154. Body 120 includes a wall 166 defining a cavity 168 in which resistive heating element 94 is positioned. Inlet 52 is in communication with cavity 168 and extends along an inlet axis 170. Inlet axis 170 extends parallel to and offset from each of outlet axis 150 and helix axis 154. The offset positioning of each of these axes induces turbulent flow and coolant mixing as the coolant passes through housing 92. Enhanced heat transfer occurs due to this relative arrangement. It should be appreciated, however, that the magnitude of the offset between outlet axis 150 and inlet axis 170 is relatively small such than any increase in back pressure to flow through heater 28 is minimized. The housing cavity 168 is also configured to eliminate “dead zones” where coolant would pool and not flow through housing 92.

In one example, the distance between outlet axis 150 and inlet axis 170 is less than the outer diameter of helical portion 140. It is further contemplated that the offset distance between outlet axis 150 and inlet axis 170 is less than one-half the outer diameter of helical portion 140. By constructing body 120 as a relatively thin walled casting, a contoured wall 160 may provide a smooth flow transition from an internal wall 166 of cavity 168 to a cylindrical wall 162 of outlet 46. The thin contoured wall 160 also minimizes the radially outward extent of an outer surface 176 of body 120. This construction lends itself toward minimizing the overall packaging volume required by heater 28.

Thermistor 96 includes a substantially cylindrical shell 180 positioned within cavity 168. A thermistor element 182 is coupled in thermal communication with shell 180. Thermistor element 182 functions by changing its resistance based on a change in temperature. Accordingly, thermistor element 182 acts as a resistor having a resistance that varies in accordance with the temperature of its surroundings. A relatively simple circuit may be constructed allowing communication between thermistor 96 and controller 110 such that controller 110 may determine a temperature of coolant positioned within heater 28 based on the output from thermistor 96.

Thermistor 96 is fixed to housing 92 thereby eliminating the need to procure and mount a separate temperature sensor downstream of inlet 52. Due to the very close proximity of thermistor 96 to resistive element 94, controller 110 may accurately estimate the operating temperature of heating element 94. During operation, controller 110 initiates a supply of current to heating element 94 when it determines that the temperature of the coolant within cavity 168 is less than a predetermined lower limit based on the thermistor signal. Controller 110 discontinues a supply of electrical energy to heating element 94 when the temperature of coolant 36 within cavity 168 exceeds a predetermined maximum.

Controller 110 may also determine the rate of coolant temperature increase within cavity 168. When the rate of temperature increase exceeds a predetermined maximum rate, controller 110 discontinues the supply of current to heating element 94. Accordingly, controller 110 prevents the overheating of heating element 94. Protection is provided should one or more of first pump 42, second pump 58 or third pump 70 cease to operate.

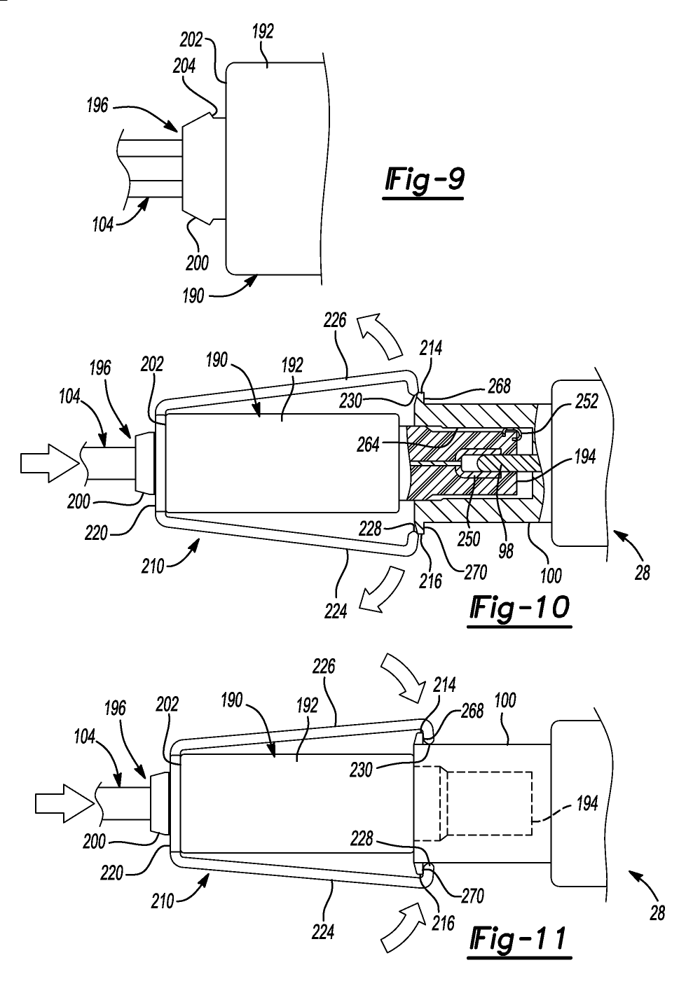

With reference to FIGS. 8-11, wire harness 104 terminates at a plug 190 including a body portion 192 integrally formed with a reduced size insert portion 194. A protrusion 196 axially extends from body 192 at an opposite end from portion 194. Protrusion 196 includes tapered walls 200 terminating at a back face 202 to define an undercut 204.

A clip 210 retains plug 190 to housing 92. Clip 210 includes a substantially planar plate portion 220 having an aperture 222 extending therethrough. Legs 224, 226 extend from edges of plate 220 spaced apart and substantially parallel to one another. Legs 224, 226 may alternatively slightly diverge from one another. Leg 224 includes a laterally inwardly extending catch 228. A laterally inwardly extending catch 230 is formed at the end of leg 226.

First, second and third wires 240, 242 and 244 extend through plug 190. First wire 240 is in electrical communication with a first terminal 250. A second terminal 252 is electrically coupled to second wire 242. A third terminal 254 is in electrical communication with third wire 244. First through third terminals 250, 252, 254 are positioned within or along insert portion 194. First and third terminals 250, 254 are positioned and shaped to receive terminal pins 98. Second terminal 252 is shaped as an external strip or tab for engagement with cap 122 to provide an electrical grounding path. Clip 210 biases terminal 252 into engagement with housing 92.

Aperture 222 of clip 210 is sized such that a snap-fit interconnection occurs as plate 220 is axially displaced over walls 200. Plate 220 is retained against back face 202 of body 192 as it enters undercut 204. Preferably, the interconnection of clip 210 and plug 190 occurs prior to coupling plug 190 to heater 28. To electrically couple heater 28 to a power source, plug 190 and clip 210 are simultaneously translated to position insert portion 194 within a cavity formed within first boss 100 and defined by a wall 264. Second terminal 252 engages and forms an electrical contact with wall 264. Upon further insertion, terminal pins 98 engage first and third terminals 250, 254. As axial translation of plug 190 and clip 210 continues, catch 228 and catch 230 engage first and second laterally extending lips 214, 216 integrally formed on first boss 100 to bias legs 224, 226 away from each other. Clip 210 may be constructed from a resilient material such as a spring steel. Once catch 228 and catch 230 axially extend beyond lips 214, 216, legs 224, 226 spring back toward their unbiased position. Body portion 192 is biased into engagement with cap 122. Similarly, catch 228 and catch 230 biasedly engage back faces 268, 270 of lips 214, 216, respectively. At this time, wire harness 104 is electrically and mechanically coupled to heater 28.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electric vehicle battery heater, comprising:
a housing having a coolant inlet and a coolant outlet;
a heating element positioned within the housing and including a helical coil portion positioned between parallel and axially extending end portions, the end portions extending outside of the housing; and
a thermistor positioned in the housing to output a signal indicative of a temperature of a coolant in heat transfer relation with an electric vehicle battery, wherein the heating element is energized when the signal represents a coolant temperature being less than a predetermined lower limit.

2. The battery heater of claim 1, wherein the coolant inlet and coolant outlet are positioned on opposite ends of the housing.

3. The battery heater of claim 2, wherein a longitudinal axis of the coolant inlet extends parallel to and offset from a longitudinal axis of the coolant outlet.

4. The battery heater of claim 3, wherein a helix axis of the helical coil portion extends parallel to and offset from each of the inlet and outlet axes.

5. The battery heater of claim 4, wherein the housing includes a body and a removable cap, the heating element and the thermistor being fixed to the removable cap.

6. The battery heater of claim 5, wherein the removable cap includes a boss defining a recess containing the end portions of the heating element.

7. The battery heater of claim 6, further including a wire harness for transferring electrical power to the heating element, the wire harness including a plug and a clip biasing the plug into engagement with the removable cap.

8. The battery heater of claim 7, wherein the clip includes a plate with an aperture in receipt of wires, the plate engaging a surface of the plug, the clip also including bifurcated legs, each leg terminating at a catch biasedly engaging the removable cap.

9. The battery heater of claim 1, wherein a spacing between adjacent wraps of the helical coil portion is less than one-half an outer diameter of the heating element.

10. An electric vehicle battery heater, comprising:
a housing including a first end having an inlet and an opposite second end having an outlet, the inlet having an inlet axis extending parallel to and offset from an axis of the outlet; and
a heating element positioned within the housing in a heat transfer relationship with a fluid passing from the inlet to the outlet, the heating element including a helical portion defining a helix axis extending parallel to and offset from each of the inlet and outlet axes.

11. The battery heater of claim 10, wherein the housing includes an inner surface spaced apart from the heating element a distance less than one diameter of the heating element.

12. The battery heater of claim 11, wherein the heating element includes end portions extending parallel to the helix axis and through the housing to provide electrical terminals.

13. The battery heater of claim 12, wherein one end portion linearly extends along the entire length of the helical portion.

14. The battery heater of claim 13, wherein the housing includes a body and a removable cap, the heating element extending through the removable cap.

15. The battery heater of claim 14, further including a wire harness for transferring electrical power to the heating element, the wire harness including a plug and a clip biasing the plug into engagement with the removable cap.

16. The battery heater of claim 15, wherein the clip includes a plate with an aperture in receipt of wires, the plate engaging a surface of the plug, the clip also including bifurcated legs, each leg terminating at a catch biasedly engaging the removable cap.

17. The battery heater of claim 10, wherein a spacing between adjacent wraps of the helical portion is less than one-half an outer diameter of the heating element.

18. The battery heater of claim 10, further including a thermistor positioned within the housing to output a signal indicative of the temperature of a fluid in the housing and a controller supplying current to the heater based on the signal indicating a temperature less than a predetermined lower limit.

19. The battery heater of claim 18, wherein the controller ceases the supply of current when the controller determines the fluid temperature is greater than a predetermined upper limit.
